(19) United States
(12) Patent Application Publication
(10) Pub. No.: US 2018/0213971 A1
(43) Pub. Date: Aug. 2, 2018

(54) Glass Lid Locking Structure for Cooking Pot

(71) Applicant: Wood Yik LAM, Hong Kong (HK)

(72) Inventor: Wood Yik LAM, Hong Kong (HK)

(21) Appl. No.: 15/420,677

(22) Filed: Jan. 31, 2017

(51) Int. Cl. A47J 36/10; E05C 3/16; E05C 19/16

(52) U.S. Cl. CPC A47J 36/10; E05C 19/161; E05C 3/167; E05C 3/162

(57) ABSTRACT

The present invention discloses a magnetic cooker's glass lid fixing structure having a lock which is rotatatable and fixed on a top side of a handle of the cooking pot. A pair of lock magnets is installed on two sides at the base of the lock symmetrically. A handle magnet of the cooking pot is installed on a location corresponding to the lock magnet at the top side of the cooker handle so that the pair of lock magnet couples magnetically with the handle magnets. When the lock is rotated 180° from a rest position, it can then hold down the glass lid firmly onto the cooking pot. The cooking pot's glass lid fixing structure of the present invention is simple and it provides a quick and easy solution to firmly hold down the glass lid onto the cooking pot.

### BACKGROUND OF THE PRESENT INVENTION

### Field of Invention

The present invention discloses a glass lid locking structure for cooking pot.

### Description of Related Arts

Conventional glass lid and cooking pot usually lacks a locking mechanism that fixes the lid towards the pot. Water straining for cooking pot will require the lid to be closed and tilted to dispense the water. The lid will fall off when this happens. It is inconvenient if the cooking pot and lid needs to be held together by hand during water straining when the lid is hot.

### SUMMARY OF THE PRESENT INVENTION

The glass lid fixing structure for cooking pot of the present invention is simple and it provides a quick and easy solution to firmly hold down the glass lid onto place. In order to solve the above mentioned objectives, the present invention discloses:

A glass lid fixing structure of cooking pot comprising; a lock, wherein the lock is rotatable and fixed on the top side of a cooking pot handle, wherein a pair of magnets are installed at the bottom of each lock mechanism. When lock is in rest position it will couple with the cooking pot handle magnetically. When lock is rotated 180° from rest position, the lock can then press against the glass lid firmly to secure the glass lid onto the cooking pot.

Furthermore, the lock is semicircle in shape.

Furthermore, the cooking pot handle is fixed onto the cooking pot by a handle fixing screw.

Furthermore, a silica gel insulating ring is positioned at a connecting junction between the cooking pot handle and the cooking pot.

Furthermore, a stainless steel insulating ring is also provided at the connecting junction between the cooking pot handle and the cooking pot.

Furthermore, the stainless steel insulating ring is provided between the silica gel insulating ring and the cooking pot handle.

Furthermore, the lock is mounted onto the cooking pot handle by a rivet and the lock is capable of rotating in axial orientation with respect to the rivet.

Compared to the conventional prior arts, the present invention has the following advantageous effect: the structure is simple and is easy to use while the cost is low. When the lock is at rest position, the lock magnets couple magnetically with the handle magnets. When the lock is rotated 180° from rest position, then the lock will hold down the glass lid firmly onto the cooking pot. Further rotation of the lock will allow itself to return to rest position and will magnetically fix against the cooking pot handle, thus the unlocked glass lid can be taken off from the cooking pot freely.

### BRIEF DESCRIPTION OF THE DRAWINGS

FIG. 1 is a structural illustration of the glass lid fixing structure of the cooking pot of the present invention.

FIG. 2 is a cross section of section A-A of the glass lid fixing structure of the cooking pot of the present invention.

FIG. 3 is a cross section of section B-B of the glass lid fixing structure of the cooking pot of the present invention.

FIG. 4 illustrates a flow diagram of operation of the glass lid fixing structure of the cooking pot of the present invention.

### DESCRIPTION OF NUMERICAL REFERENCE

1—glass lid; 2—lock; 3—rivet; 4—handle of the cooking pot; 5—handle fixing screw; 6—silica gel insulating ring; 7—stainless steel insulating ring; 8—cooking pot; 9—lock magnet; 10—handle magnet.

### DETAILED DESCRIPTION OF THE PREFERRED EMBODIMENT

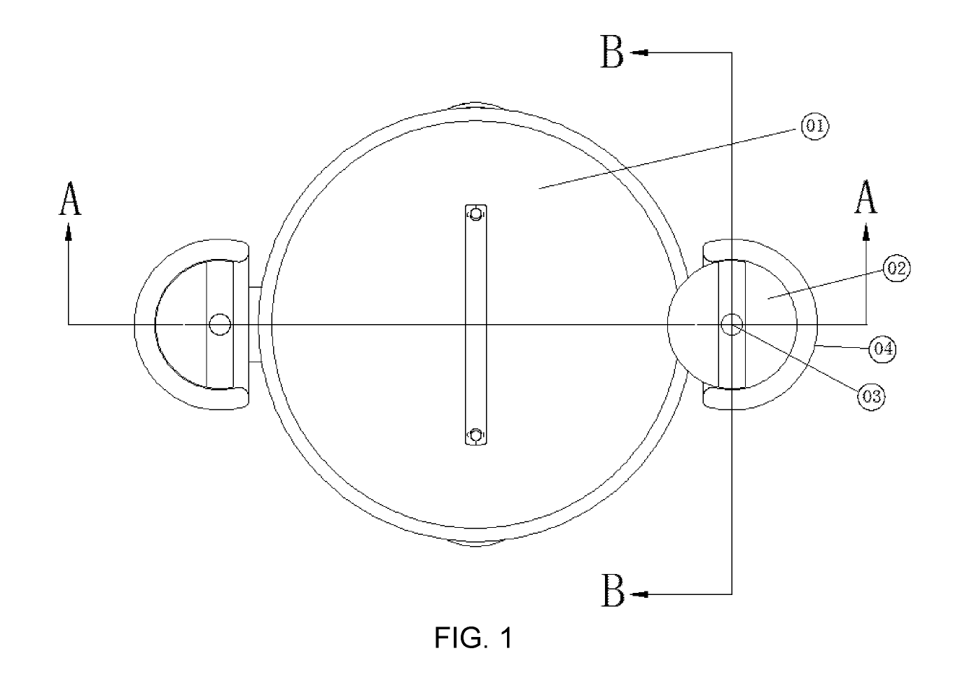

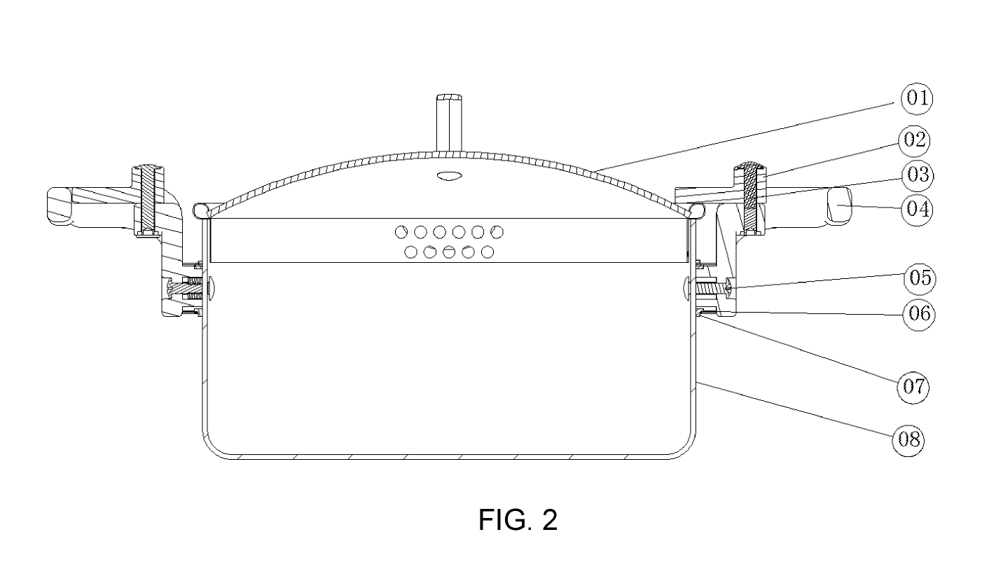

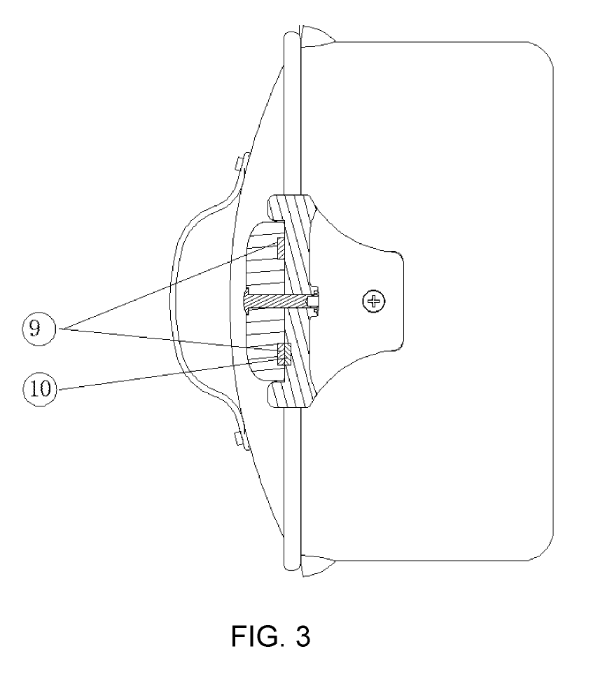

Referring to FIGS. 1-3 of the drawings, a glass lid fixing structure of a cooking pot according to the present invention is illustrated. The glass lid locking structure of a cooking pot comprises a lock 2 which is semicircle in shape. The lock 2 is rotatable and is fixed by a rivet 3 (the rivet 3 serves as the axis for rotation) on a top side of the handle 4 of the cooking pot 9. Each lock 2 includes two magnets, one on the right side and one on the left side installed. The handle of the cooking pot also comprises 2 handle magnets 10 which is installed in a corresponding position to the lock magnets 9 which can couple magnetically with the handle magnets 10 of the cooking pot 9. When the lock 2 is rotated 180° from a rest position, the lock 2 can then hold down a glass lid 1 firmly onto a cooking pot 8.

The lock 2 in the rest position does not engage the glass lidl. After rotating the lock 2 in a predetermined angle to reach a locking position, the lock 2 will engage the glass lid 1 to press against it so that the glass lid 1 is firmly locked in place. By continuing the rotation of the lock 2 from the locking position in a predetermined angle, the lock 2 will then disengage the glass lid 1. The lock 2 can be in any tangible shape as long as the rotation of the lock 2 allows the user to select the rest position and the locking position.

The handle of the cooking pot 4 is fixed onto the cooking pot 8 by a handle fixing screw 5. A silica gel insulating ring 6 is inserted between the handle of the cooking pot 4 and the cooking pot 8. A stainless steel insulating ring 7 is also inserted between the handle of the cooking pot 4 and the cooking pot 8. The stainless steel insulating ring is inserted between the silica gel insulating ring 6 and the cooking pot handle 4.

The steps of utilizing the present invention are as follows:

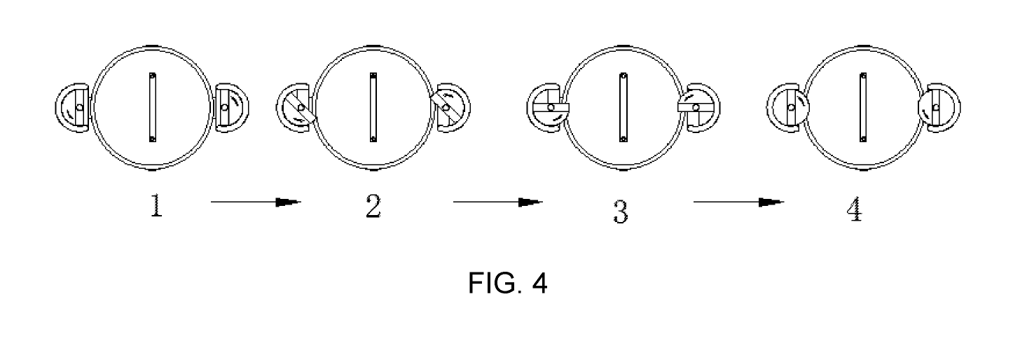

According to FIG. 4 of the drawings, when the lock 2 is rotated to a position as shown in the first step, the lock magnets 9 are on the bottom side of the lock 2 which can couple magnetically with the handle magnets 10 of the cooking pot on the handle 4 of the cooking pot, thus magnetically fixing the lock 2 in the rest position. When the user desires to lock the glass lid 1, the user can rotate the lock 2 by 180° to reach the locking position as shown in step 4. In the locking position, the semicircle shape lock 2 will press against the glass lid 1 so that the lock 2 will firmly hold the glass lid 1 in place. In this configuration, the liquid or article stored inside the cooking pot 8 may be poured out via an opening of the cooking pot without taking off the glass lid 1. This technique of pouring with glass lid on is commonly known as ‘straining’.

The above detailed description of the preferred embodiment is the preferred mode of carrying out the invention. The description is not to be taken in any limiting sense. It is presented for the purpose of illustrating the general principles of the present invention.

What is claimed is:

1. A glass lid fixing structure of a cooking pot comprising: a lock, wherein the lock is rotatable and is fixed on a top side of a handle of the cooking pot, wherein a pair of lock magnets is installed on both two sides end at a bottom of the lock symmetrically, wherein a pair of handle magnets of the cooking pot is installed on a location corresponding to the lock magnets at the top side of the handle of the cooking pot so that the pair of lock magnets couples magnetically with the handle magnets, wherein when the lock is rotated 180° from a rest position, the lock can then press against the glass lid firmly to secure the glass lid onto the cooking pot.

2. The glass lid fixing structure of a cooking pot as recited in claim 1, wherein the lock is semicircle in shape.

3. The glass lid fixing structure of a cooking pot as recited in claim 1, wherein the handle of the cooking pot is fixed onto the cooking pot by a handle fixing screw.

4. The glass lid fixing structure of a cooking pot as recited in claim 3, wherein a silica gel insulating ring is provided at the connecting junction between the handle of the cooking pot and the cooking pot.

5. The glass lid fixing structure of a cooking pot as recited in claim 3, wherein a stainless steel insulating ring is provided between the handle of the cooking pot and the cooking pot.

6. The glass lid fixing structure of a cooking pot as recited in claim 4, wherein a stainless steel insulating ring is provided between the silica gel insulating ring and the handle of the cooking pot.

7. The glass lid fixing structure of a cooking pot as recited in claim 1, wherein the lock is mounted onto the handle of the cooking pot by a rivet and the lock rotates about the rivet axially in which the rivet is the axle for rotation.
